(19) United States
(12) Patent Application Publication
(10) Pub. No.: US 2002/0175900 A1
(43) Pub. Date: Nov. 28, 2002

(54) Touch input system

(76) Inventor: Donald B. Armstrong, Belmont, CA (US)

Correspondence Address: TYCO ELECTRONICS CORPORATION, MAIL STOP R20/2B, 307 CONSTITUTION DRIVE, MENLO PARK, CA, 94025, US

(21) Appl. No.: 10/116,442

(22) Filed: Apr. 4, 2002

Related U.S. Application Data
(60) Provisional application No. 60/281,457, filed on Apr. 4, 2001.

(51) Int. Cl. G09G 5/00

(52) U.S. Cl. 345/173

(57) ABSTRACT

In one aspect, the present invention provides a touch input system for use with an information display system. The touch input system includes a frame have four sides defining a touch input area. On each side is positioned an array of light emitting devices. In a preferred embodiment, the light emitting devices are organic light emitting diodes. A light transmissive prism is positioned along each array of light emitting devices such that light emitted from the light emitting devices is directed across the touch input area. The system also includes light detection device positioned at each corner of the frame.

### CROSS-REFERENCE TO RELATED APPLICATIONS

This application is an application under 35 USC 111(a) and claims priority under 35 USC 119 from Provisional Application Serial No. 60/281,457, filed Apr. 4, 2001 under 35 USC 119(b).

### BACKGROUND OF THE INVENTION

1. Field of the Invention

This invention relates to a touch input system for use with an information display system. More particularly, the present invention is directed to an optical touch input system for use with a flat panel display.

2. Introduction to the Invention

Touch input systems have become ubiquitous throughout industrialized countries.

These systems have replaced or supplemented conventional input systems, such as a keyboard or mouse in many applications, including for example, information kiosks, retail point of sale, order input, e.g. restaurants, and industrial line operations. Various types of touch input systems are currently in the marketplace. These include acoustic, resistive, capacitive and infrared. The present invention is directed primarily to infrared touch input systems. As with most technologies, a key to market penetration is improving quality and performance while reducing production costs. The present invention addresses at least one of these aspects in that it enables for reduced part count and the resulting savings in costs. The present invention also provides for touch analysis which in turn improves the system performance.

The present invention will typically be used in conjunction with some type of information display system, for example a flat panel display connected to a computer system. Typically, the computer system provides a variety of screens on the display illustrating a selection of objects that may be selected by a user. When the user touches one of the objects the touch input system communicates the location of the touch to the computer system. The information display system typically includes two pairs of oppositely disposed sides that define an information display area.

### BRIEF SUMMARY OF THE INVENTION

In a first aspect this invention provides a touch input system, comprising a frame having a first pair of opposed sides positioned parallel to a first axis and a second pair of opposed sides positioned parallel to a second axis, the second axis being perpendicular to the first axis, each of the second pair of sides connecting the first pair of sides, all four sides defining a generally rectangular touch input area, a linear array of light emitting devices along each side, and a light detection device positioned at each corner of the frame.

In a second aspect this invention provides a touch input system, comprising a touch screen comprising a frame having a first pair of opposed sides positioned parallel to a first axis and a second pair of opposed sides positioned parallel to a second axis, the second axis being perpendicular to the first axis, each of the second pair of sides connecting the first pair of sides, all four sides defining a generally rectangular touch input area, a linear array of light emitting devices along each side, and a light detection device positioned at each corner of the frame; and a controller coupled to the light emitting devices and the light detection devices, wherein the controller sequentially activates each linear array and activates the light detection devices positioned at corners of the frame opposed to the activated array of light emitting devices.

### BRIEF DESCRIPTION OF THE DRAWINGS

FIG. 1 is a perspective view of a touch input system of the present invention.

FIG. 2 is a planar, schematic view of a touch input system of the present invention.

### DETAILED DESCRIPTION OF THE INVENTION

The information display system may include a flat panel display having two pairs of oppositely disposed sides (S₁, S₂, S₃, and S₄) defining an information display area I. The touch input system 10 of the present invention may include a frame L having two pairs of oppositely disposed sides (L₁, L₂, L₃, and L₄) defining an open area corresponding in size and shape to the information display area I. Each of the sides of the touch frame includes a linear array of a light emitting devices (E₁, E₂, E₃, and E₄). In a preferred embodiment, the light emitting devices are organic light emitting devices (OLEDs) that emit light in the infrared (IR) range. The touch input system 10 also includes a light detecting device (D₁, D₂, D₃, and D₄) positioned at each corner of the frame L. In a preferred embodiment the light detecting device is an IR phototransistor. In a preferred embodiment, the touch input system 10 includes a light transmissive prism (P₁, P₂, P₃, and P₄) positioned along and adjacent each linear array of light emitting devices (E₁, E₂, E₃, and E₄) such that light emitted from the light emitting devices is directed across the information display area I. By activating the plurality of arrays and the individual light emitting devices within each array in a defined sequence and simultaneously activating specific ones of the light detecting devices, the touch input system of the present invention can determine the location of a touch on the information display area I.

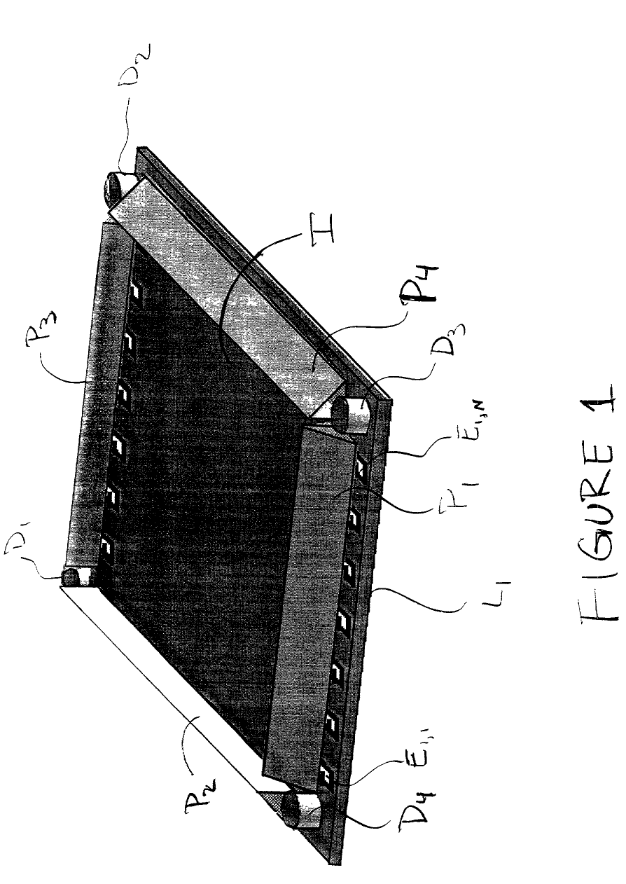

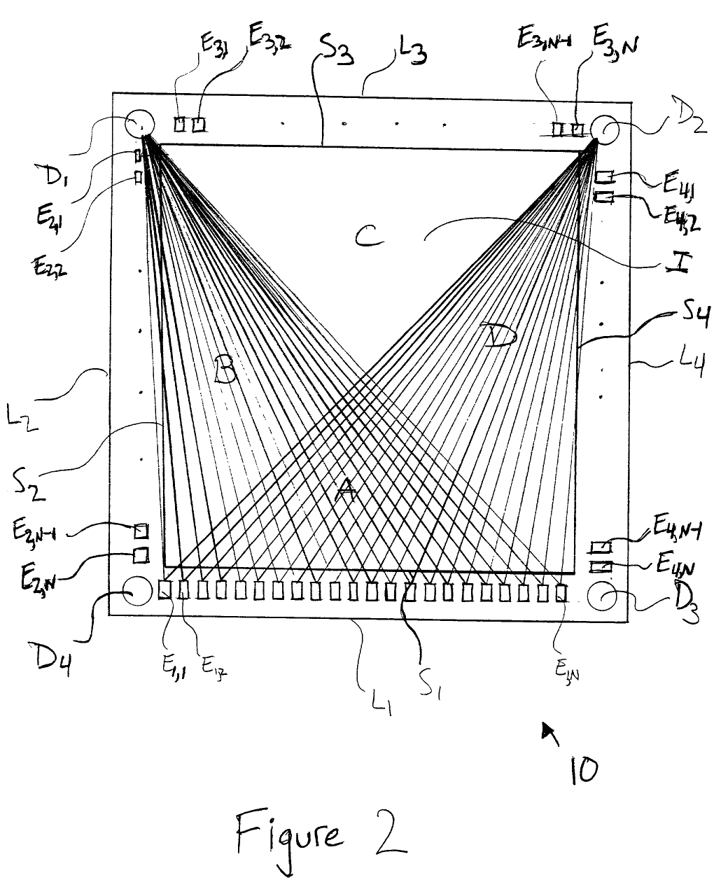

Referring to FIGS. 1 and 2, the present invention may be clearly understood. The information display system includes a display device, for example a flat panel display having four sides (S₁, S₂, S₃, and S₄) defining a information display area I. In a preferred embodiment, the touch input system 10 includes a frame L having four sides (L₁, L₂, L₃, and L₄) defining an opening corresponding in size and shape to the information display area I. In an alternate embodiment, the frame may overlay a portion of the area defined by the four sides of the display device, therein providing less usable display area for touch applications. The touch input system 10 includes a linear array of light emitting devices (E₁, E₂, E₃, and E₄) along each of the four sides of the frame L₁, L₂, L₃, and L₄, respectively. Each array includes a plurality of individual light emitting devices. In the illustrated embodiment, each array includes N light emitting devices however the system may have a different number of devices in each array. Typically, the number of devices in opposing arrays will be the same to provide a rectangular or square frame. In a preferred embodiment the individual light emitting devices are Organic Light Emitting Diodes (OLEDs) that emit in the infrared (IR) band. For example, the OLEDs may be doped with rare earth ions such as neodymium or erbium. The touch input system 10 also includes a light detecting device (D₁, D₂, D₃, and D₄) positioned at each corner of the frame. In the preferred embodiment, the detecting devices are IR detectors such a silicon phototransistors. The touch input system also includes a light transmissive prism (P₁, P₂, P₃, and P₄) positioned along each array E₁, E₂, E₃, and E₄, respectively.

Each of the individual OLED elements of each array are electrically connected to a controller system (not shown) which enables one to individually activate each of the elements. In some embodiments this controller system is comprised of a combination of circuit elements dedicated to the touch system function as well as circuit elements supporting both display and touch functions. By activating individual ones of the light emitting elements and specific ones of the light detecting devices, one can determine the location of a touch within the information display area I. More particularly, by sequentially activating the light emitting devices E_{1,1}-E_{1,N} along a first side L₁ of the frame and activating the light detecting devices D₁ and D₂, one can monitor a first space A of the information display area I.

Similarly, by activating the light emitting devices E_{2,1}-E_{2,N} along a second side L₂ of the frame and activating the light detecting devices D₂ and D₃, one can monitor a second space B of the information display area I. Similarly, by activating the light emitting devices E_{3,1}-E_{3,N} along a third side L₃ of the frame and activating the light detecting devices D₃ and D₄, one can monitor a third space C of the information display area I. Finally, by activating the light emitting devices E_{4,1}-E_{4,N} along a fourth side of the frame and activating the light detecting devices D₄ and D₁, one can monitor a fourth space D of the information display area I.

Alternately, a course scan/fine scan approach can be implemented. In a touch detect mode, sequential blocks of light emitting elements may be activated to approximately locate a touch. Once the approximate location of a touch is determined a more precise location can be measured by sequential activation of a limited segment of individual light emitting elements determined by the approximate location determination.

By implementing an algorithm, e.g. based on the equations presented in Japanese Patent Application No. 59-115205 (Laid Open No. 60-257304), that converts the direct polar readings observed by the detectors to x, y coordinates, one can discern the location of a touch within the information display area I.

The foregoing detailed description of the invention includes passages which are chiefly or exclusively concerned with particular parts or aspects of the invention. It is to be understood that this is for clarity and convenience, that a particular feature may be relevant in more than just the passage in which it is disclosed, and that the disclosure herein includes all the appropriate combinations of information found in the different passages. Similarly, although the various figures and descriptions thereof relate to specific embodiments of the invention, it is to be understood that where a specific feature is disclosed in the context of a particular figure, such feature can also be used, to the extend appropriate, in the context of another figure, in combination with another feature, or in the invention in general.

It will be understood that the above-described arrangements of apparatus are merely illustrative of applications of the principles of this invention and many other embodiments and modifications may be made without departing from the spirit and scope of the invention as defined in the claims.

What is claimed is:

1. A touch input system, comprising:
a frame having a first pair of opposed sides positioned parallel to a first axis and a second pair of opposed sides positioned parallel to a second axis, the second axis being perpendicular to the first axis, each of the second pair of sides connecting the first pair of sides, all four sides defining a generally rectangular touch input area;
a linear array of light emitting devices along each side; and
a light detection device positioned at each corner of the frame.

2. The touch input system of claim 1, wherein each array of light emitting devices are sequentially activated and the light detection devices positioned at corners opposed to the activated linear array are activated to detect a touch within the touch input area.

3. The touch input system of claim 2, wherein each light emitting device within each array of light emitting devices is sequentially activated.

4. The touch input system of claim 1, wherein polar readings are used to define a touch location within the touch input area.

5. The touch input system of claim 2, wherein the activated light detection devices detect a touch within a quadrant of the touch input area.

6. The touch input system of claim 5, wherein the quadrant is defined as an isosceles triangle having the side of the frame with the activated light emitting devices as a base.

7. The touch input system of claim 1, wherein the light emitting devices are light emitting diodes.

8. The touch input system of claim 1, wherein the light emitting devices are organic light emitting devices and further comprising a light transmissive prism positioned along each array of light emitting devices such that light emitted from the light emitting devices is directed across the touch input area towards opposed light detection devices.

9. A touch input system, comprising:
a touch screen comprising
a frame having a first pair of opposed sides positioned parallel to a first axis and a second pair of opposed sides positioned parallel to a second axis, the second axis being perpendicular to the first axis, each of the second pair of sides connecting the first pair of sides, all four sides defining a generally rectangular touch input area;
a linear array of light emitting devices along each side; and
a light detection device positioned at each corner of the frame; and
a controller coupled to the light emitting devices and the light detection devices, wherein the controller sequentially activates each linear array and activates the light detection devices positioned at corners of the frame opposed to the activated array of light emitting devices.

10. A touch input system of claim 9, wherein the controller sequentially activates each light emitting device within an activated array.

11. A touch input system of claim 9, wherein the light emitting devices are organic light emitting devices and further comprising a light transmissive prism positioned along each array of light emitting devices such that light emitted from the light emitting devices is directed across the touch input area towards opposed light detection devices.

12. A touch input system of claim 9, wherein the activated light detection devices detect a touch within a quadrant of the touch input area.
